(19) United States
(12) Patent Application Publication
(10) Pub. No.: US 2003/0011799 A1
(43) Pub. Date: Jan. 16, 2003

(54) Command protocol for two color thermal printing

(76) Inventors: Andrew M Kobziar, Ithaca, NY (US); Steven Spano, Ithaca, NY (US)

Correspondence Address: George R McGuire, Hancock & Estabrook, 1500 Mony Tower I, PO Box 4976, Syacuse, NY, 13221-4976, US

(21) Appl. No.: 10/182,496

(22) PCT Filed: Jan. 11, 2002
(86) PCT No.: PCT/US02/01047

(51) Int. Cl. B41F 1/00; G06F 15/00

(52) U.S. Cl. 358/1.11; 358/1.15; 358/1.18

(57) ABSTRACT

Command protocol for enhancing the appearance of two-color thermal printing. The methods provide sales receipts with watermarks, strike-throughs, and graphic surrounding an item. These added functions can be accomplished in real time. Some of them can be printed in distinguishing colors.

### CROSS REFERENCE TO RELATED APPLICATION:

The present invention is the U.S. National Stage Filing of PCT Application No. PCT/US02/01047, filed Jan. 11, 2002, which claims priority to U.S. Provisional Application Serial No. 60/261,365, filed Jan. 12, 2001.

### TECHNICAL FIELD

The present invention relates to thermal printing of sales receipts and, more particularly, to methods of safeguarding and enhancing the appearance of sales receipts by printing in two colors and in real time.

### BACKGROUND ART

Printing sales receipts in two colors is well known in the art. The two colors, such as red and black, draw attention to and emphasize certain important items on the receipt, such as sales tax, discounts, and non-taxable items. Two color printing of receipts has the capability of providing further benefits to both consumers and vendors, such as improving security by reducing forgeries, erasures, and receipt duplication. However, the current state of the art has not advanced to provide for these functions.

It is a principal object of this invention to provide a command protocol for enhancing thermal printing of sales receipts.

It is a further object and advantage of the present invention to improve the appearance of sales receipts by adding a strike-through function, a watermark, and a graphic surrounding an item.

It is an additional object and advantage to improve the security of the receipt against erasures, forgeries, and receipt duplications.

Other objects and advantages of the present invention will in part be obvious, and in part appear hereinafter.

### SUMMARY OF THE INVENTION

In accordance with the present invention, there are provided methods of safeguarding and of enhancing the appearance of sales receipts. The methods of this invention are unique to Point-Of-Sale printers; they provide sales receipts with watermarks, strike-throughs, and circles-about-an-item. These added functions can be accomplished in real time. Some of them can be printed in differentiating colors. A strike-through function is obtained by selectively adding a dot row to the center of the font cell. The strike-through has application in the voiding of purchased items and in emphasizing the old price in a discounted item. The watermark function embeds a predefined shaded logo or graphic into the receipt paper, in order to discourage fraud and counterfeiting. The watermark process can print the watermark in red, which cannot be copied on black print only copiers. The graphic is filtered to provide a faded background image. The method of adding a surround graphic-about-an-item can be selected to highlight specific text. The ellipse form of the surround graphic can be partially broken or completely closed. The method uses a set of four command parameters in accordance with a command protocol developed specifically for POS printing.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a plan view of a typical font cell being modified to provide a strike-through function;

FIG. 2 depicts a plan view of a strike-through being used to emphasize the new sale price of a sales item;

FIG. 3 shows a flow chart diagram for the method of providing a strike-through for a sales receipt;

FIG. 4 illustrates a flow chart diagram for the process of generating a watermark on a sales receipt;

FIG. 5 depicts a plan view of printed sales receipt items featuring the standard and “free-hand” ellipse-about-an-item function, in accordance with this invention; and

FIG. 6 shows a flow chart diagram of the method of providing the ellipse-about-an-item function as shown in FIG. 5.

### DESCRIPTION OF THE PREFERRED EMBODIMENT

Generally speaking, the invention features command protocols for enhanced thermal printing of sales receipts. The command protocols of this invention provide sales receipts with watermarks, strike-throughs, and surround graphic-about-an-item. These added functions can be accomplished in real time. Some of them can be printed in distinguishing colors.

Now referring to FIG. 1, a typical font cell 10 for standard ASCII text is shown. The font cell 10 was obtained with a 203 dpi thermal printer. The font cell 10 is thirteen dots wide by twenty-four dots high in the preferred embodiment, but the technique applies to any rectangular shaped cell.

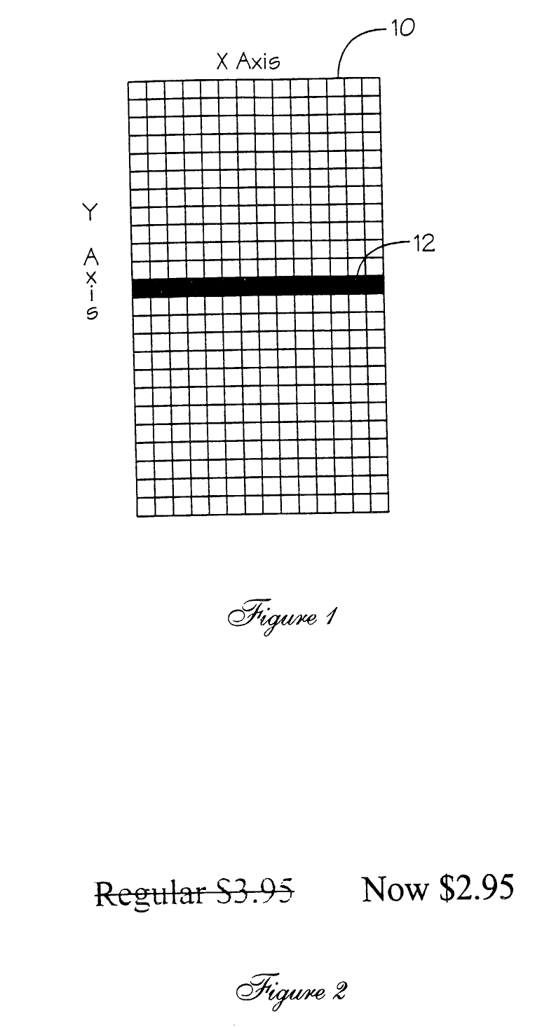

In order to achieve a strike-through, a command is given by the user through a communication link (not shown) that selectively marks a dot row 12 in the center of the font cell 10. The marked dot-row 12 comprises the same or alternate color as its destination character or characters. The strike-through function is illustrated in FIG. 2. It is often used to void purchased items, sales prices, etc., and to highlight discount pricing.

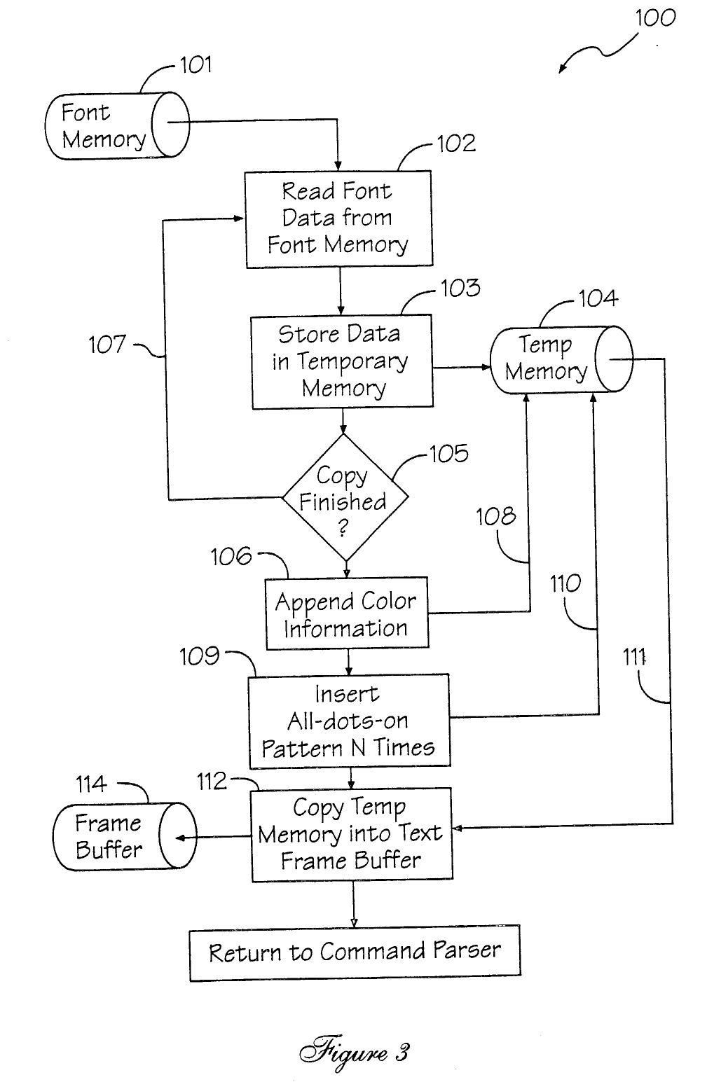

Referring to FIG. 3, a flow chart 100 depicts the method used to obtain the strike-through shown in FIG. 2. Font data is extracted from font memory 101 and read, step 102. The data is then stored in temporary memory 104, step 103. If the data has been completely extracted, step 105, then color information is added, step 106. If the data has not been completely extracted, step 105, continued attempts are made to extract and read font data, step 102, via feedback loop 107.

Having properly appended the color information, step 106, this is stored in temporary memory 104, as per feed line 108. After the color information has been appended, the dots used for the strike-through function are inserted, step 109. This information is also sent to temporary memory 104 via line 110. The temporary information is then copied into the text frame buffer 114, step 112. This is achieved via line 111. The program sequence then returns to the command parser.

The so-called watermark function is a real-time operation that is intended to embed a logo or design into the sales receipt, in order to prevent fraud by fabricating a counterfeit or erroneous receipt. The watermark function combines arbitrary text on receipts, with a predefined logo or graphic. This graphic is a shaded version of a standard logo in order to achieve a faded effect. The watermark is then merged, in real time, with the text stream. The result is a receipt with a faded image in the background. The graphic is printed in its predefined color. A red watermark discourages counterfeiting, because the graphic is difficult to photocopy.

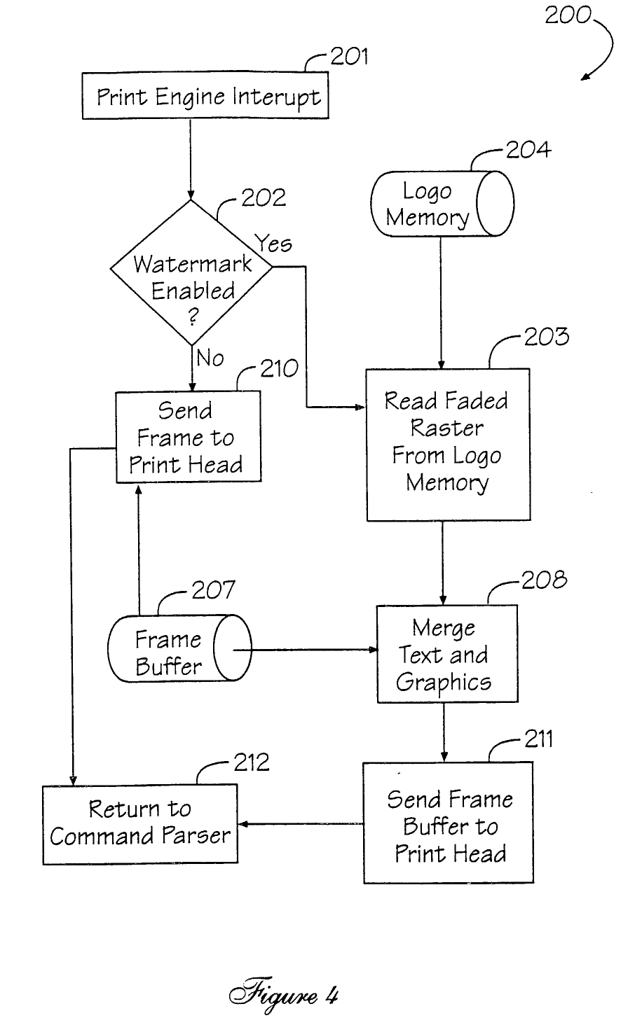

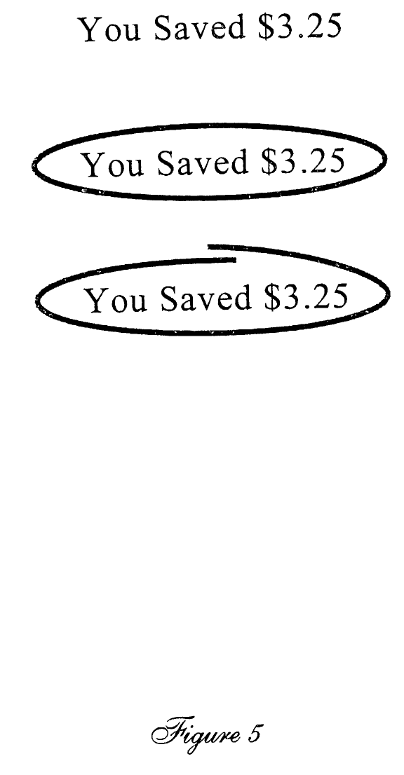

Referring to FIG. 4, a flow chart 200 shows the method of achieving a watermark when printing a sales receipt. A print engine interrupt signal allows the enablement of the watermark, step 201, via decision block 202. When the watermark is enabled, a raster is read, step 203, from logo memory 204. The graphic is then merged with text, which is secured from the frame buffer 207. The text can be sent to the print head either directly, step 210, or from the merged graphic, step 211. The program sequence then returns to the command parser.

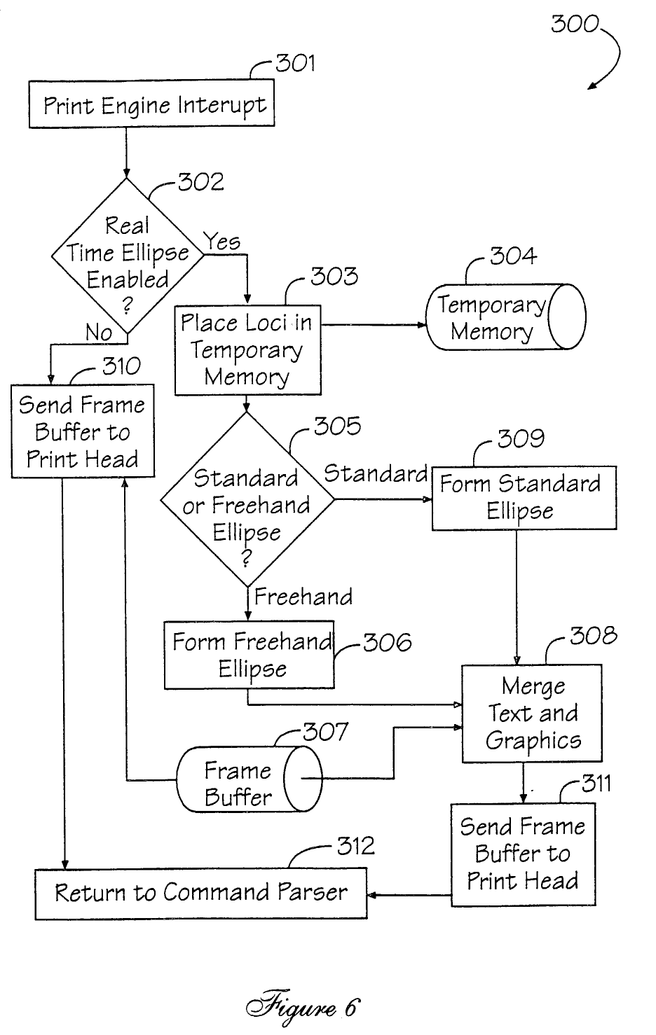

The ellipse-about-an-item command is designed to allow the user to circle a number of lines of ASCII text at any location on the receipt. The term “ellipse” is used herein to indicate an enclosing or partially enclosing shape, including other curved shapes, both regular and irregular polygons, and even straight lines and bars. The ellipse is intended to provide an additional method for highlighting or emphasizing some section of the receipt. The command can be selected to create a closed or partially broken ellipse, as shown in FIG. 5. The command uses a set of four command parameters with two parameters used to initiate the sequence. The user, therefore, must transmit six bytes of data. A typical sequence is illustrated below, in hexadecimal form:

1Bₕ XXₕ Field1ₕ Field 2ₕ Field 3ₕ Field 4ₕ

As aforementioned, the command is composed of six bytes, of which the first byte 1Bₕ is an industry standard character (ESC). This character designates a command sequence. The second byte XXₕ refers to a newly defined command code. This code is used to signify the real-time surround graphic sequence. The last four parameters (Field1ₕ through Field4ₕ) are used as coordinate and image selection controls. Table 1, shown below, illustrates the use of these fields:

TABLE I

| | | |
|---|---|---|
| Field 1 | Left Hand Center/Loci. | Number is based on the |
| | | maximum allowable characters |
| | | per line. |
| Field 2 | Right Hand Center/Loci. | Number is based on the |
| | | maximum allowable |
| | | characters per line. |
| Field 3 | Y axis dimension. | This is limited from a |
| | | range of 1 through 4. |
| | | The field specifies the |
| | | number of lines that the |
| | | circle will encompass. |
| Field 4 | Equation/Image selection | (Closed ellipse, “free- |
| | | hand” ellipse etc.) |

Referring to FIG. 6, a flow chart 300 is shown for providing an ellipse about a number of lines of text in a sales receipt. A print engine interrupt signal allows the enablement of the ellipse, step 301, via decision block 302. When the ellipse is enabled, loci are placed in temporary memory 304, step 303. Next, a decision is made as to whether the ellipse is to be closed or broken, step 305. If a broken ellipse is to be formed, step 306, it is merged with text, step 308 which is secured from the frame buffer 307. If a closed ellipse is to be formed, step 309, it is merged with text, step 308, which is likewise secured from the frame buffer 307. The text can be sent to the print head either directly, step 310, or from the merged text and ellipse image, step 311. The program sequence then returns to the command parser.

The two-color, thermal command protocol is described hereinbelow.

2-Color Thermal Commands

Command Name: Set Paper Type

Command: 1D 81 m n

Parameter: This command sets the current printing mode based on monochrome or color. The m n parameters select paper category and formulation version, respectively.

Command Name: Print Raster Monochrome Graphics

Command: 1D 82 n1 . . . n72 (576 dots) for 80 mm paper, or n80 (640 dots) for 82.5 m paper

Parameter: n1 to n72/n80 corresponds to one dot row data for a thermal receipt printer. Each bit defines whether a dot of the current default color will be printed. This command is used for printing a singe raster monochrome graphic in real-time.

Command Name: Print Raster Color Graphics

Command: 1D 83 n1 . . . n144 (576 dots 80 mm paper)/n160 (640 dots, 82.5 mm paper)

Parameter: n1 to n144/n160 corresponds to one dot row data. For each printed dot row starting at the top left, a two-part bit string is used to define in the first half, all dots that are of either color (i.e., not white), and the second half string defines only the dots where the color=black. This command is used for printing a single raster of color graphics in real-time.

Command Name: Download Logo Image

Command: 1D 84 m n1 n2 d1 . . . dx, x=(n1* n2*8)*m

m=1 if monochrome, m=2 if 2-color

Max n1=576/8 for 80 mm paper or 640/8 for 82.5 mm paper

Parameter: The value of the current logo is the logo index to be used to store the downloaded graphic.

m identifies whether the image is monochrome (which requires one parameter bit row description) or 2-color, which requires a pairing of bit descriptions for each row.

n1*n2 define a rectangular image n1 bytes wide and n2 bytes long. n1*8 specifies the number of dot columns, and n2*8 the number of dot rows. This command is used for storing a logo of n1 by n2 size indexed by the current logo value.

Command Name: Reverse Color Text Mode

Command: 1D 85 m n

Parameter: This command sets a mode for reverse printing effects on text. The background color is specified by m, and the color for text characters by n. As in the case of the white/black reverse mode, the parameter m=0 turns off the mode irrespective of n and is the initial value.

m, n=0: white

m, n=1: black

m, n=2: paper-color

Command Name: Monochrome Shade Mode

Command: 1D 86 m

Parameter: This applies a selected shade density to all monochrome objects such as text and monochrome logos. The parameter m specifies the shading effect and has an initial value of 0 which signifies no effect.

m specifies the percentage of shading, 0<=m<=100. If >0 then Color Shade Mode is turned off as well.

m=0 is the initial value and turns this mode off.

Command Name: Color Shade Mode

Command: 1D 87 m

Parameter: This applies a mixing of color into any monochrome objects such as text and monochrome logos. Rather than fading away, this mode transitions a character or logo from the Current Color in which it would normally be printed to the other color. The parameter m specifies the shading effect and has an initial value of 0 which signifies no effect. m specifies the percentage of shading, 0<=m<=100.

m specifies the percentage of shading, 0<=m<=100. If >0 then Monochrome Shade Mode is turned off as well.

m=0 is the initial value and turns this mode off.

Command Name: Merge Side Bars Mode

Command: 1D 88 nL nH m s

Parameter: This command will merge into any subsequent print two solid bars on the far opposite sides of the paper printable area. The bars are defined by: width n in dots and by color m. n<=576/2, or <=640/2 with 82.5 mm paper if s=0 or twice those values otherwise.

nL is the low order byte, and nH is the high order byte of a 16 bit word specifying the width.

nL, nH=0 is the initial value and turns this mode off.

m selects the color

m=0 (monochrome) is the initial value;

m=1 (2-color paper “primary color”, usually black);

m=2 (second color available from 2-color paper).

s=0 bars on both left and right side,

s=1 left side only side bar,

s=2 right side only side bar.

Command Name: Logo Print with Color Plane Swap

Command: 1D 89 n m

Parameter: This command will print logo n. The command is ignored if a logo with index n has not been defined. If m=0 the color(s) as defined in the logo are used; if m=1 and if the logo is a color one, then the two color planes (black and paper-color) in the logo are swapped.

2-Color Image Processing

Command Name: Merge Barcode Sidebars Mode

Command: 1D 8A h c s w m n d1 . . . dn

Parameter: This command will place into a background graphics buffer (which will be merged when output printing occurs) sidebars one or both sides. A sidebar is defined as being of thickness h, consisting of color c and side selection s- as in the parameters nLm s of the Merge Sidebars Mode command. h=nL, c=m, and s=s of the parameter descriptions in that command.

Command Name: Apply Shading To Logo

Command: 1D 8B n m o

Parameter: This command will apply shading effect m to logo n and store it at index o, also extending width to full horizontal size if logo n is not at full paper width.

n must be the index value of an existing logo

0<=m<=100, possibly resulting in a logo suitable for background watermark mode use

o can be any value, and the logo will be placed according to the current setting of user storage into RAM or Flash memory.

Command Name: Merge Watermark Mode

Command: 1D 8C n m

Parameter: This command will insert the logo m as a repeated background image, similar to printing a visible watermark, into the print stream. The space between repetitions of this usually shaded logo will be every n*8 dot rows.

n=0 is the initial value and turns this mode off.

n>0=number of dot rows x8 to skip before repeating the merge action.

m specifies the index value of the logo. If no logo has been defined with this index then the command is ignored.

Command Name: Text Strike Through Mode

Command: 1D 8D n m

Parameter: This command will merge into any text character cell n rows of dots of full cell width, vertically centered in the cell. For a cell with an even number of rows, the first one below the middle is used, then the one above, then the one below that pair, etc. The parameter m specifies the color of the merged dot rows, and the strike through overrides all previous dot content.

m=0 retain same color as the character itself

m=1 (black)

m=2 (paper-color)

n=0 is the default; n<=standard cell height. If the strike through is as wide as is the cell height, then this will produce a cell that will be printed as a solid box current color.

Command Name: Download Paper Type Description

Command: 1D 8E nL nH d1 . . . dn

Parameter: This command will store in Flash memory a paper type description identified by the structure in d1 . . . dn, adding the uniquely (by type category and version) identified structure for subsequent use by the Set Paper Type Command. nL+nH*256

define the number of bytes x that follow. These bytes contain the proprietary structure and CRC to operate the thermal print head.

Command Name: Return Paper Type Description

Command: 1D 8F m

Parameter: This command will return from Flash memory a paper type description indexed by m, (0<=m<=15) sending back the data sequence used in the Download Paper Type Description command, i.e. the return is 1D 8F m nL nH (d1 . . . dn) which was stored in slot m; or a value of n=0 if slot m does not have a description stored. For all valid descriptions, the last two bytes will be a CRC value and the first 24 bytes will be as follows:

| # | | |
|---|---|---|
| Bytes | Offset | Definition |
| 1 | 0 | Manufacturer Paper Type Category |
| 1 | 1 | Version in Type Category |
| 1 | 2 | Printhead Type |
| 1 | 3 | Structure Format Type |
| 20 | 4 | Descriptive name as a null |
| | | terminated ASCII string |

A value of m=FF will return the currently selected paper type.

Command Name: Form and Merge Real Time Surround Graphic

Command: 1D 90 m x y o p q

Parameter: This command will print a real-time graphic style designated by m. m=0 rectangle, m=1 oval, m=2 ellipse (if printed in a square area the ellipse becomes a circle), m=3 is a 5 point star, m=4 is a free hand underline, m=5 is a free hand ellipse and other values of m reserved for future styles. This graphic is formed into a RAM based Graphics buffer, and the buffer state is set to “graphic merge pending”.

Command Name: Save Graphics Buffer as Logo

Command: 1D 91 n

Parameter: This command will save all the raster data that is in the working Graphics buffer (where surround graphics are formed) as a logo with index value n. This logo can then be used repeatedly for inserting different text. See the Background Logo Print command.

Command Name: Background Logo Print Mode

Command: 1D 92 n

Parameter: This command will place into the Graphics buffer the logo designated by n. As soon as there is a print action command (such as text output) the graphics buffer will be merged (logical OR process) with print output.

Command Name: POS UStatus Modes

Command: 1D 96 m n

Parameter: This command enables or turns off the unsolicited sending of printer state values back to the host whenever there is a change in any of the printer's configured states. An option is provided to return printer state on a timed basis (i.e., a pseudo state change=timer running out). The modes settings can enable unsolicited responses which return a state change notification that can optionally have appended a command count and status of the last command executed. A persistent version of this command is also available; it would setup the unsolicited modes to be retained by the printer across power loss instances. Both timed and unsolicited modes can be on simultaneously via issuing the command again with a different parameter setting. The state values returned are from the state enumeration table described in the Printer Extended Command Status command.

Interpretation of command parameters:

| | | |
|---|---|---|
| m = 0 | n | turn all POS Ustatus Modes off |
| | immaterial | |
| m = 1 | n = 0 | turn on unsolicited status |
| | | reporting without power fail |
| | | option |
| m = 1 | n = 1 | turn on unsolicited status |
| | | with power fail option |
| m = 2 | n = 0 | turn on unsolicited + last |
| | | command status without power |
| | | fail option |
| m = 2 | n = 1 | turn on unsolicited + last |
| | | command status with power fail |
| | | option |
| m = 3 | n = # | turn on timed status reporting |
| | seconds | |
| | if n = 0 | |
| | then off | |
| m = 4 | n = # | turn on timed + last command |
| | seconds | status reporting |
| | if n = 0 | |
| | then off | |

Command Name: User Storage Status

ASCII: GS Ox97 m n

Hexadecimal: I D 97 m n

Decimal: 29 151 m n

Parameter: m specifies the type of stored object to be reported:

m=0 return the kilobytes (1024) of free User RAM,

n=0 gets largest free block size

n=1 gets the total size free

m=1 return the kilobytes of free Character & Logo Flash memory, n=0

m=2 return the kilobytes of free User Data Flash memory, n=0

m=3 return the CRC of a logo indexed by n

m=4 return the CRC of a downloaded character set, selected by n

m=5 return the CRC of a macro that has been stored, n=0

For m=0 the value n selects a return of either the largest free block or total free size, since contiguous allocation cannot be assumed as this area is completely under user control through address parameters.

n=0 if only one instance of an object type is allowed (macro, User Data, User Defined Characters).

n is the item index when more than one object of type m is possible

n<=FE, see the comments about logo and character set indexes

n=FF: return a list describing all the existing items of type m

When a specific item request is made, a returned CRC value of 0 0 indicates that no item is stored at that index. There is a practically negligible possibility that a valid object will have a 0 0 CRC; if this is of concern, applications should check the object downloaded byte sequence to verify that this is not the case (as well as store the CRC as an “ID” for the object if needed later for return value comparisons).

User Defined characters' CRC is requested as m, n=4, 0.

Downloaded Character sets are identified by integer extending the existing Code Page selection as enumerated in the Select

International Character Set (=Select Character Code Table) command. The firmware standard list is incrementally extended each time a new single or double byte set is downloaded.

Single byte downloaded fonts are selected by m=3 and 0x40<=n<0x80.

Since only three double-byte character sets are supported, the value 0x80/0xA0/0xC0 selects the first, second, third downloaded double byte font respectively. In return, each downloaded double byte character band is reported individually as 0xC0, 0xC1, 0xC2 . . . for as many bands as have been defined.

This command returns the state of occupancy of available Flash storage and user RAM. The printer response for each item is a 4 byte header, 0x1D 0x97 nL nH (no. of bytes that follow in the response) and for each item a 4 byte structure: 1st m(type) byte, 2nd n index byte followed by a 2 byte CRC in Lo Hi order of the data string in that storage space.

The return for m=0-2 is the header and one 4 byte item giving remaining storage space in the CRC position in Lo Hi order: ID 97 4 0 m 0 fL fH, where f is the Kbytes of storage remaining. Note that RAM storage space is not content typed, while available Flash is statically divided into logo, character set, and user data types. Change of the divisions is possible via Flash erasure and Flash allocation commands.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A command protocol for printing an image, comprising the steps of:
a) placing information representative of graphics in memory; and
b) dynamically merging said graphics information with text during a printing step.

2. The command protocol in accordance with claim 1, wherein said information is hierarchically organized.

3. The command protocol in accordance with claim 1, further comprising the steps of:
i) creating surround graphics; and
ii) storing said surround graphics in a buffer.

4. The command protocol in accordance with claim 3, wherein said surround graphics are selected from the group of free form underline, ellipse, rectangle, oval, star and free hand ellipse.

5. The command protocol in accordance with claim 3, wherein said surround graphics is sized to be at least as large as said text to be surrounded.

6. A command protocol for printing in multi-color reverse of a POS printer, comprising the steps of:
a) setting a first color for print text;
b) setting a second color for background;
c) in response to a reverse color text command, redefining the color for said background; and
d) printing the reversed text and background in real time.

7. The command protocol in accordance with claim 6, wherein said reverse color text command in step (c) is 1D85.

8. A method for printing sidebars on multi-color paper, the steps comprising:
a) setting the width of said at least one sidebar(s);
b) determining the side or sides on which said at least one sidebar is to be printed;
c) setting the color of said at least one sidebar; and
d) d) whenever a dot-row is printed, merging in said at least one sidebar therewith.

9. The method for printing in sidebars in accordance with claim 8, the steps further comprising:
a) replacing said at least one sidebar with a value representative of a one-dimensional barcode; and
b) holding said barcode within solid sidebars and repeatedly merging said barcode and sidebars as dot-rows are printed.

10. A method for printing a watermark on multi-color paper, the steps comprising:
a) selecting a graphic to serve as a watermark and downloading it to a printer as a logo;
b) applying shading to said logo to fade out the graphic image; and
c) whenever a dot-row is printed, merging said watermark therewith.

11. A method for printing strike-through on multi-color paper, the steps comprising:
a) selecting a thickness of a strike-through line;
b) selecting a color of said strike-through line;
c) turning on a strike-through mode;
d) whenever a character is printed, replacing the middle portion thereof with strike-through dots; and
e) printing said modified character.

12. A method for identifying, handling, downloading and saving a paper type description, the steps comprising:
a) assigning a value for an index, said value comprising at least one byte;
b) assigning a value that defines the version of parameter structure;
c) identifying a body of parameters;
d) receiving validity check bytes; and
e) saving parameters in non-volatile memory.

13. A method for setting paper type, the steps comprising:
a) matching an index value to an index of a saved body of parameters; and
b) moving said parameters into a hardware assist chip.

14. A method for returning a paper type description, the steps comprising:
a) matching an index value to a saved index;
b) retrieving said saved parameter data structure;
c) retrieving data validity check bytes; and sending said retrieved data to a host processor.

15. A method for returning the status of storage area reserved for users in a printing system, the steps comprising:
a) obtaining a designation representative of storage type on which status is to be reported;
b) obtaining identification of a predetermined item of interest;
c) retrieving requested status information; and
d) sending said retrieved status information to the host computer.

16. The method for returning the status of storage area reserved for users in accordance with claim 15, the steps further comprising: repeating said retrieving step (c) for multiple predetermined items.

17. The method for returning the status of storage area reserved for users in accordance with claim 15, the steps further comprising: calculating a CRC value dependent upon the presence and identification of said requested status information.
